(19) United States
(12) Patent Application Publication
(10) Pub. No.: US 2007/0061319 A1
(43) Pub. Date: Mar. 15, 2007

(54) Method for document clustering based on page layout attributes

(75) Inventor: Andre Bergholz, Grenoble (FR)

Correspondence Address: PALMER & DODGE, LLP;RICHARD B. SMITH, 111 HUNTINGTON AVENUE, BOSTON, MA, 02199, US

(73) Assignee: Xerox Corporation

(21) Appl. No.: 11/222,881

(22) Filed: Sep. 9, 2005

(51) Int. Cl. G06F 17/30

(52) U.S. Cl. 707/5

(57) ABSTRACT

A method for document clustering based on page layout attributes is disclosed. A method for clustering a document page collection includes obtaining a document page collection, each document page in the collection having one or more features, the one or more features defining a page layout attribute; extracting information from the one or more features on each document page and constructing a feature vector; computing a distance metric based on an assigned feature weight for each feature; and clustering the document page collection using the distance metric.

### RELATED APPLICATIONS

None.

### FIELD

The embodiments disclosed herein relate to clustering of document page collections, and more particularly to methods for clustering document page collections based on page layout attributes.

### BACKGROUND

Clustering document collections into conceptually meaningful clusters is a well-studied problem. In many clustering tasks, unlabeled data is plentiful but labeled data is limited and expensive to generate. Consequently, semi-supervised clustering, which employs a small amount of labeled data to aid and bias the clustering of unlabeled data, has been developed. Existing methods for semi-supervised clustering fall into two general approaches, constraint-based methods and distance-based (metric-based) methods. In constraint-based approaches, the clustering algorithm itself is modified so that the available labels or constraints are used to bias the search for an appropriate clustering of the data. In distance-based approaches, an existing clustering algorithm that uses a distance measure is employed; however, the distance measure is first trained to satisfy the labels or constraints in the supervised data. Various methods of clustering document collections are described in U.S. Pat. No. 5,619,709 entitled “System and Method of Context Vector Generation and Retrieval”, U.S. Pat. No. 6,542,635 entitled “Method for Document Comparison and Classification Using Document Image Layout”, U.S. Pat. No. 6,598,054 entitled “System and Method for Quantitatively Representing Data Objects in Vector Space”, U.S. Pat. No. 6,658,626 entitled “User Interface for Displaying Document Comparison Information”, and U.S. Pat. No. 6,922,699 entitled “System and Method for Quantitatively Representing Data Objects in Vector Space”, all of which are incorporated by reference in their entireties for the teachings therein.

Prior attempts for clustering document collections typically rely on extracting unique content-bearing words from the set of documents, treating these words as features, and then representing each document as a vector of certain weighted word frequencies in this feature space. Typically, a large number of words exist in even a moderately sized set of documents where a few thousand words or more are common; hence the document vectors are very high-dimensional. Thus, there is a need in the art for methods of clustering of document pages based on layout rather than content. By using a distance-based approach to semi-supervised clustering, document page collections can be clustered efficiently based on document page layout attributes.

### SUMMARY

Methods for clustering a document page collection based on page layout attributes are disclosed herein.

According to aspects illustrated herein, there is provided a method for computing a distance metric for a document page collection that includes obtaining a document page collection, each document page in the collection having one or more features, the one or more features defining a page layout attribute; extracting information from the one or more features on each document page; constructing a feature vector for the one or more features on each document page; assigning a feature weight to each feature; and computing a distance metric based on the feature weight and the feature vector.

According to aspects illustrated herein, there is provided a method for evaluating a generated clustering for a document page collection that includes obtaining a document page collection, each document page in the collection having one or more features, the one or more features defining a page layout attribute; choosing a sample of document pages from the collection; computing a reference clustering for the sample of document pages; extracting information from the one or more features on each document page in the sample; constructing a feature vector for the one or more features on each document page; assigning a feature weight to each feature; computing a distance metric between any two pages in the sample of document pages based on the feature weight and the feature vector; clustering the sample of document pages using the distance metric in a clustering algorithm to obtain a generated clustering for the sample of document pages; and comparing the reference clustering to the generated clustering.

According to aspects illustrated herein, there is provided a method for clustering a document page collection that includes obtaining a document page collection, each document page in the collection having one or more features, the one or more features defining a page layout attribute; extracting information from the one or more features on each document page and constructing a feature vector; computing a distance metric based on an assigned feature weight for each feature; and clustering the document page collection using the distance metric.

### BRIEF DESCRIPTION OF THE DRAWINGS

The presently disclosed embodiments will be further explained with reference to the attached drawings, wherein like structures are referred to by like numerals throughout the several views. The drawings are not necessarily to scale, the emphasis having instead been generally placed upon illustrating the principles of the presently disclosed embodiments.

FIG. 1 illustrates the unique and characteristic page layout attributes (also referred to as features) of six different document page types that may be used with the methods disclosed herein: title page 115; one-column text page 130; two-column text page 145; one-column text page with image 160; mixed text page with various column widths and images 175; and an index page 190.

FIG. 2 illustrates an exploded view of some of the page layout features associated with page layout 175 from FIG. 1. The attributes include paragraphs, images and a page number.

FIG. 3 is an exemplary illustration of some of the extracted feature information obtained from page layout 175 from FIG. 1.

FIG. 4 is a flow diagram for the method of generating a clustering for a document page collection.

FIG. 5 is a flow diagram for the method of determining a reference clustering.

FIG. 6 is a schematic diagram showing an iterative approach for searching and evaluating the correct feature weights and the correct distance measure for a sample of document pages from a document page collection.

FIG. 7 is a flow diagram for the method of determining the correct feature weights and the correct distance measure for a sample of document pages from a document page collection based on the schematic from FIG. 6.

FIG. 8 is a schematic diagram showing a direct approach for searching and evaluating the correct feature weights and the correct distance measure for a sample of document pages from a document page collection.

FIG. 9 is a flow diagram for the method of determining the correct feature weights and the correct distance measure for a sample of document pages from a document page collection based on the schematic from FIG. 8.

FIG. 10 is a flow diagram for the method of clustering a document page collection once the correct feature weights are determined.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

A method for clustering a document page collection is disclosed. In the method for clustering a document page collection, a reference clustering on a sample of document pages from the collection is computed, one or more features from each of the document pages in the sample are extracted and assigned a weight, a distance metric between two pages in the sample of document pages is computed based on the assigned feature weights, the sample of document pages are plugged into a clustering algorithm and a clustering of the sample of document pages is generated, the generated clustering is compared to the reference clustering and if any modifications are necessary new feature weights are assigned, and the document page collection is plugged into the clustering algorithm, using the learned feature weights.

“Document” as used herein refers to any printed or written item containing visually perceptible data, as well as to any electronic or data file which may be used to produce a printed or written item. A document may be a hardcopy, an electronic document file, one or a plurality of electronic images, electronic data from a printing operation, a file attached to an electronic communication or data from other forms of electronic communication. A “document page collection” or “collection of document pages” as used herein includes, but is not limited to, at least two pages, sheets, labels, boxes, packages, tags, boards, signs and any other item which contains or includes a “writing surface” as defined herein below. Typically, a document page collection includes more than two pages. In an embodiment, the document page collection includes at least six pages. In an embodiment, the document page collection includes at least twenty pages. In an embodiment, the document page collection includes at least fifty pages. “Writing surface” as used herein includes, but is not limited to, paper, cardboard, acetate, plastic, fabric, metal, wood, adhesive backed materials and similar surfaces.

“Features” as used herein refers to attributes found on a document including, but not limited to, paragraphs, images (icons, graphics, pictures, clip art), page numbers, tables and graphs. “Information” extracted from the features includes, but is not limited to, the number of paragraphs in a document page (1 feature); the total area of all paragraphs on a document page (1 feature); the paragraph coordinates of their upper left and lower right corner (there are four coordinates for every paragraph: upper left x-coordinate (X1), upper left y-coordinate (Y1), lower right x-coordinate (X2), and lower right y-coordinate (Y2), each coordinate is represented by five values, the minimum and maximum, the mean, and the quartiles for a total of 20 features); the paragraph widths and heights (10 features); the number of textboxes per paragraph (5 features); the font size of the paragraphs (5 features); the number of images in a page (1 feature); the total area of images in a page (1 feature); the image widths and heights (10 features); the number of SVG-type images (1 feature); the vertical fill degree (1 feature—all text and images are projected to the Y-axis, and then the percentage of the “occupied” space on the Y-axis is used as a feature); the number of vertical spaces (1 feature—output the number of spaces between lines of texts and images, gives an indication about the fill degree and fragmentation of the page; the size of the vertical spaces (5 features—each vertical space on the page is recorded and use the five numbers as features) the number of textboxes ending with a number (1 feature); -Left, right, one-sided, and two-sided paragraph areas (4 features—the set of all paragraphs is divided into those that are completely in the left half of the page, those that are completely in the right half of the page, and those that overlap both halves. The total area of the first set (left paragraphs area), the total area of the second set (right paragraphs area), the total area of both the first and the second set (one-sided paragraphs area), and the total area of the third set (two-sided paragraph area) are added together; -Left, right, one-sided, and two-sided image areas (4 features); and the page number (1 feature). Some of the features may be derived from other features, for example, width and height can be computed from the coordinates. For some features more than one representation is selected. For example, the number of textboxes per paragraph could be represented by the average or the mean over all paragraphs on a page. To get a better picture of the overall distribution, the minimum and maximum, the mean, and the quartiles are added (the values at 25% and 75% of the overall spectrum).

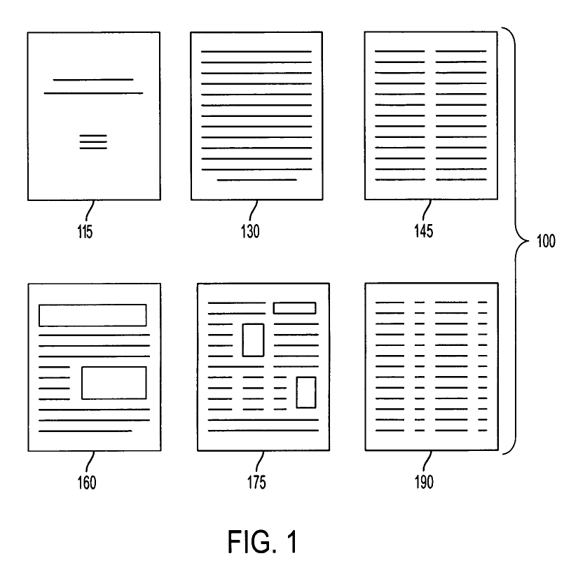

FIG. 1 is an illustrative example of six different types of document page layouts that makeup a document page collection 100. The document page collection 100 may include a title page 115; a one-column text page 130; a two-column text page 145; a one-column text page with two images 160; a mixed text page with various column widths and three images 175; and an index page 190. Those skilled in the art will recognize that the document page collection 100 may include any document page layout that contains any of the features as described below.

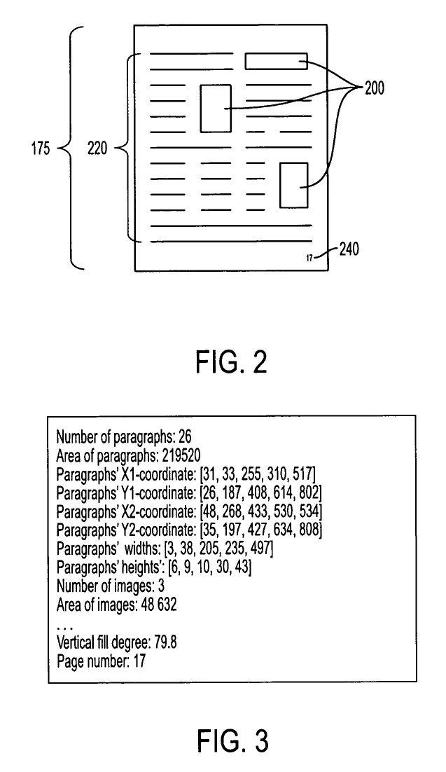

FIG. 2 is an exploded view of the document page layout 175 from FIG. 1. The document page layout 175 includes one or more features, for example, images, shown generally at 200, paragraphs, shown generally at 220, and a page number 240.

FIG. 3 is an example of some of the feature information that has been extracted from the document page 175 from FIG. 2 using the methods disclosed herein. For example, the paragraph coordinates of the first paragraph on the document page has an upper left X-coordinate (X1), upper left Y-coordinate (Y1), lower right X-coordinate (X2), and lower right Y-coordinate (Y2). To get a better picture of the overall distribution, each coordinate (X1, Y1, X2 and Y2) is represented by five points, the minimum, the maximum, the mean, and the quartiles.

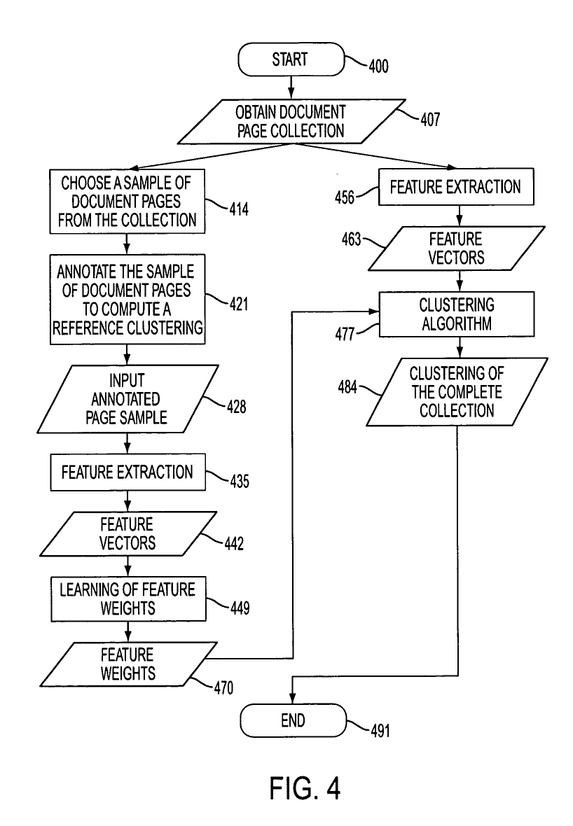

FIG. 4 is a flow diagram illustrating the steps of a method for clustering a document page collection, each page in the collection having one or more features. The method includes computing a reference clustering for a sample of document pages from the collection; learning a distance metric for the sample of document pages based on the weights of one or more features associated with each document page in the sample; and applying the distance metric to a clustering algorithm to cluster the collection of document pages.

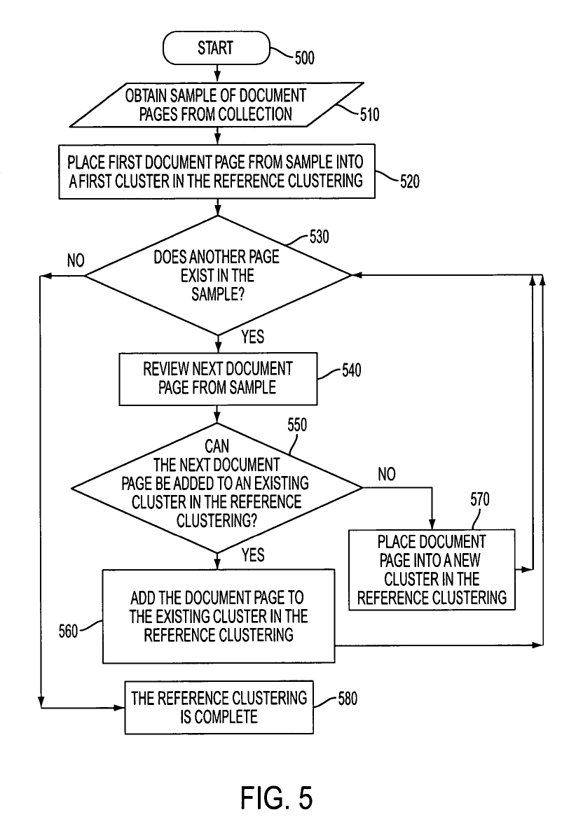

The method starts at 400 and includes obtaining a document page collection that a user wishes to cluster, as shown in step 407. Each of the document pages of the collection has one or more features. In step 414, a sample of document pages from the collection is selected. The sample of document pages is annotated to compute a reference clustering in step 421. Step 421 includes a user browsing the sample of document pages and clustering the sample by hand to produce a reference clustering. The annotation process will be further described in FIG. 5 discussed below.

After the sample of document pages is clustered by hand, and the reference clustering is computed, the user inputs the annotated sample of document pages into an electronic document processing system in step 428. Typically, the electronic document processing system generally includes an input device for electronically capturing the general appearance (i.e., the content and the basic graphical layout) of a hardcopy sample of document pages; programmed computers for enabling the user to create, edit and otherwise manipulate an electronic version of the sample of document pages; and printers for producing hardcopy renderings of the electronic version of the sample of document pages. The input device may include one or more of the following known devices: a copier, a xerographic system, an electrostatographic machine, a digital image scanner (e.g., a flat bed scanner or a facsimile device), a disk reader having a digital representation of the sample of document pages on removable media (CD, floppy disk, rigid disk, tape, or other storage medium) therein, or a hard disk or other digital storage media having the sample of document pages as images recorded thereon. Those skilled in the art will recognize that the method would work with any device suitable for storing a digitized representation of a sample of document pages.

The sample of document pages may be in any electronic format for which the one or more features can be extracted and includes, but is not limited to, the following open formats, ASCII, PostScript, PDF, HTML, XML (in particular XHTML and SVG). Document types such as Microsoft Word, Excel, and PowerPoint can be converted into XML format by appropriate software (available as PDF2XML or CambridgeDocs, for example). In an embodiment, the sample of document pages is in XML format. The XML format may display features including, but not limited to, TEXT, PARAGRAPH, and IMAGE. The one or more features are marked with attributes indicating the x-position and y-position of the one or more features on the document page, the width and height of the one or more features and further information, such as text font name and size. Information regarding the one or more features in the XML document may be extracted for each document page in the sample as shown in step 435.

Once the feature information is extracted for each document page, an n-dimensional feature vector is created as shown step 442. For example, for two pages pᵢ and pⱼ the feature vectors ƒᵢ and ƒⱼ are created. The distance metric d(pᵢ, pⱼ) between page pᵢ and page pⱼ is the weighted sum of the distances between the different features of the pages:

$$d ( {p}_{1} , {p}_{j} ) = {\sum }_{k = 1}^{n} {λ}_{k} {d}_{k} ( {f}_{i} [ k ] , {f}_{j} [ k ] )$$

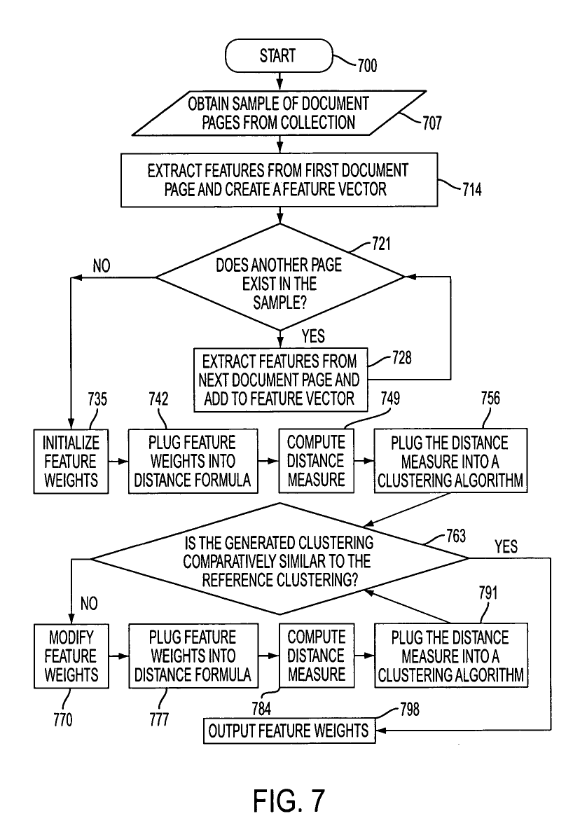

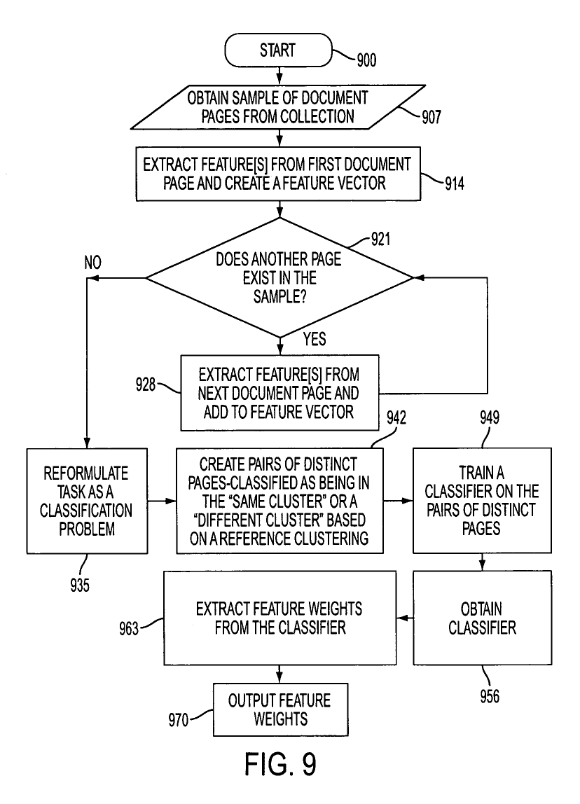

The n distance functions dₖ for the features are often just the absolute value of the difference of the feature values |ƒᵢ[k]−ƒⱼ[k]|. For some features, in particular area features (i.e., area of paragraphs, area of images) the square root of that distance |ƒᵢ[k]−ƒⱼ[k]| is used instead. The disclosed embodiments are not limited to any particular choice. An important step is to learn the feature weights λₖ in step 449. A search is performed to search for the values of the feature weights. The weights of the one or more features are assigned an initial value and the distance metric is computed from the initial value. The distance metric is used in a clustering algorithm to generate a clustering for the sample of document pages. The generated clustering is evaluated against the reference clustering, and based on this evaluation the feature weights may be modified or kept the same. The search and evaluation steps are further described in FIGS. 7 and 9 below.

After the search and evaluation steps are performed to determine the feature weights, step 470, the method continues to step 477. Initially, the entire document page collection is processed through the electronic processing system, so that the same features are extracted from the entire document page collection as shown in step 456. The feature extraction process will result in a much larger set of feature vectors as shown in step 463. The feature weights determined from the sample of document pages are now used to determine the distance metric for the overall collection by plugging in the distance metric into a clustering algorithm as shown in step 477. The result is a clustering of the complete document page collection as shown in step 484. The method terminates at step 491.

FIG. 5 is a flow diagram illustrating a method for producing a reference clustering. The method starts at step 500 and includes a user obtaining a sample of document pages from a document page collection, as shown in step 510. In step 520, the user reviews the first document page from the sample and places the page in a first cluster in the reference clustering. Initially, the reference clustering is empty and does not contain any document pages. The method then proceeds to step 530, where the sample of document pages is checked to determine if another document page exists. If another document page exists, then the method continues to step 540 and the next document page from the sample is reviewed. The document page is reviewed to determine whether a cluster already exists in the reference clustering for the document page currently being reviewed as shown in step 550. If a cluster does exist, the document page is added to the cluster in the reference clustering as shown in step 560. If the document page does not belong in any existing cluster, a new cluster is created in the reference clustering as shown in step 570. The method then returns to step 530 and method steps 540, 550, 560 and 570 are continued until all the document pages from the sample have been reviewed and placed into a cluster in the reference clustering. Once all of the document pages from the sample have been reviewed and placed into a cluster in the reference clustering, the method continues to step 580 and a complete reference clustering is produced.

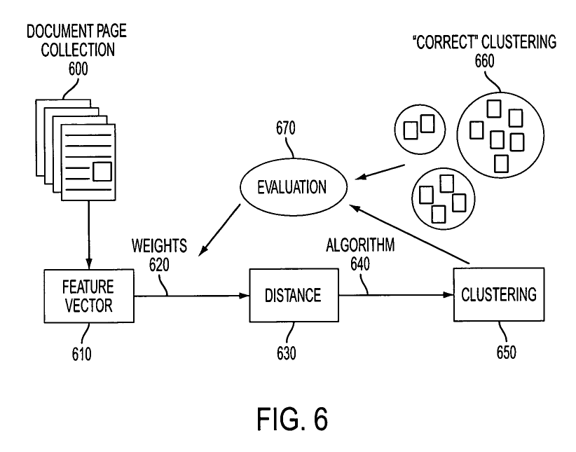

FIG. 6 is a schematic diagram showing the search and evaluation steps for determining the correct feature weights and the distance metric for a sample of document pages. The search and evaluation steps shown in FIG. 6 are based on a semi-supervised clustering approach that is iterative. In an embodiment, the search and evaluation is based on a simple search method. In an embodiment, the search and evaluation is based on a genetic algorithm method.

In the simple search approach, a sample of document pages 600 from a document page collection is obtained and the feature information associated with each page is extracted to create a feature vector set 610 Initially, all feature weights 620 are given a value of 1/n, where n is the total number of features. A distance 630 between two document pages in the sample is determined, as described above, and then the document pages are given to a clustering algorithm 640. The clustering algorithm 640 produces some generated clustering 650, and the generated clustering 650 is compared 670 to a reference clustering 660, also known as the “correct” clustering. Then, the features are reviewed one by one and the weights 620 of the respective features are increased by multiplying the features with a certain factor a. If this weight 620 update yields a better clustering 650, then the update is kept permanent. The iterative procedure is repeated until no further improvement is achieved. In an embodiment, the value of a ranges from about 1.1 to about 20.

In the genetic algorithm approach, the feature weights 620 are encoded as chromosomes. A pool of chromosomes is created; in every chromosome every feature weight 620 is initialized to be a random number between 0.0 and 1.0. The usual operations of mutation (reinitialization to a random value), crossover and selection are applied. Selection is based on the fitness of a chromosome, which translates to the evaluation of the clustering 650 imposed by the feature weights 620 encoded in the chromosome. Besides the size of the pool, there are other parameters: the number of generations, the probability of a mutation, the probability of a crossover, and other parameters known to those skilled in the art.

In an embodiment, the clustering algorithm used is hierarchical agglomerative clustering algorithm 640, including single-link, complete-link, and average-link clustering. In agglomerative clustering each object is initially treated as a separate group (cluster). Then, clusters are successively combined based on similarity until there is only one cluster remaining or a specified termination condition is satisfied. In an embodiment, the clustering algorithm is an average-link clustering algorithm. Those skilled in the art will recognize that the methods disclosed herein can be used with any clustering algorithm and still be within the scope and spirit of the presently disclosed embodiments.

FIG. 7 is a flow diagram illustrating the iterative method based on the schematic from FIG. 6. The method steps allow for finding the feature weights that maximize the similarity between the generated clustering and the reference clustering. The method starts at 700 and includes obtaining a sample of document pages 600 from a document page collection, as shown in step 707. A user inputs the sample of document pages 600 into an electronic document processing system. In step 714, a feature vector set 610 is constructed by extracting features from the first document page from the sample. In step 721, the sample is checked to determine if another document page exists in the sample. If another document page exists, the features from the page are extracted and added to the feature vector set 610 as shown in step 728. Once the features from all of the document pages 600 from the sample have been extracted, the method proceeds to step 735. In step 735, the feature weights 620 are initialized, either randomly or set to be all equal (the former is done for genetic algorithm, the latter for simple search). With the feature weights 620 fixed, the feature weights 620 are plugged into the distance formula in step 742 and a distance metric 630 between any two pages may be computed in step 749. The sample of document pages 600 may now be clustered using the distance metric 630 and a clustering algorithm 640, resulting in a clustering 650 (also known as generated clustering) of the sample as shown in step 756. This clustering 650 is evaluated 670 against a human-given reference clustering 660 as shown in step 763. If the evaluation 670 is similar, the feature weights 620 are output as the result as shown in step 798. Otherwise, another iteration is run, and the feature weights are modified as shown in step 770. The new feature weights are then plugged into the distance formula in step 777 and a new distance metric 630 between any two pages is computed in step 784. The sample of document pages 600 may now be clustered again using the new distance metric 630 and the clustering algorithm 640, resulting in a new generated clustering 650 in step 791. This clustering 650 is evaluated 670 against the human-given reference clustering 660 in step 763. The process is repeated until the generated clustering and the reference clustering are similar. In the simple method, weights of features are increased one by one, in the genetic algorithm genetic operations such as mutation and crossover are used, and the evaluation is followed by a selection step.

To give back feedback to the search algorithm, the clustering produced by a particular choice of feature weights has to be evaluated. That is, the generated clustering has to be compared to the reference clustering. Various evaluation indexes have been proposed to compare two clusterings including, but not limited to, the rand index, the Jacquard similarity index, the split/join distance and the variation of information measure. In an embodiment, the variation of information measure is used as the evaluation method.

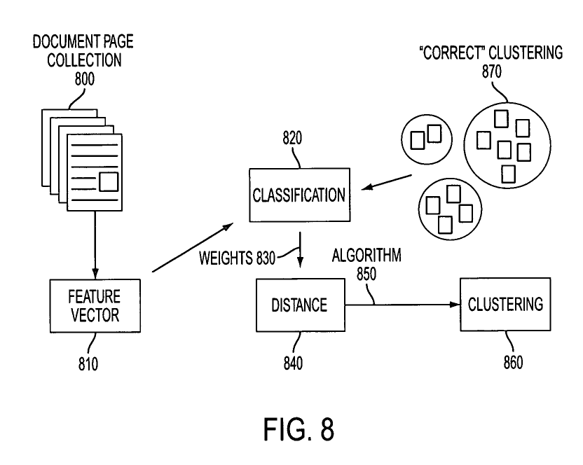

FIG. 8 is a schematic diagram showing the search and evaluation steps for determining the feature weights and the distance metric for a sample of document pages. The search and evaluation steps shown in FIG. 8 are based on a semi-supervised classification approach that is direct. In an embodiment, the search and evaluation is based on a maximum entropy classification method. In an embodiment, the search and evaluation is based on a linear program classification method.

In FIG. 8, a sample of document pages 800 from a document page collection is obtained and the feature information associated with each page is extracted to create a feature vector set 810. The feature vector set is used to construct a classification 820 problem. The reference clustering 870 is used to determine whether two pages from the sample 800 are in the “same cluster” or in a “different cluster”. From the constructed classifier 820 the feature weights 830 are extracted, which form a distance measure 840 to be used in a clustering algorithm 850. The clustering algorithm 850 can then be used to cluster 860 the document page collection.

In the maximum entropy approach, the maximum entropy classification method is used to detect the weights 830 of the features. Two classes are created: “same cluster” and “different cluster”. For the maximum entropy classifier 820, a training sample is created for each pair of points (document pages) of the original clustering problem. Each new training sample has n features, namely the n “feature distance” values dₖ(ƒᵢ[k],ƒⱼ[k]). Each training sample is assigned the class “same cluster” if both points of the pair are in the same cluster in the reference clustering 870, otherwise the sample is assigned the class “different cluster”. Maximum entropy classification is performed with the created sample set. The maximum entropy algorithm creates a model in which each feature is assigned a certain weight. The n weights are extracted from the model and output as the learned feature weights 830 for the original problem.

In the linear program approach, the output weights 830 are calculated in one go by reformulating the optimization goal. The goal is to derive a linear program from the original problem, which can then be solved using standard techniques. All pairs of points (document pages) (pᵢ,pⱼ) are considered. S is the set of point pairs, where both points belong to the same cluster, and T is the set of point pairs, where the points belong to a different cluster.

If pᵢ and pⱼ are in the same cluster (i.e., (pᵢ,pⱼ)εS), then the two document pages are used to formulate the optimization goal. The goal is to find feature weights 830 that minimize the distances 840 between points in the same cluster. So, the optimization goal is to minimize the sum of all distances 840 between point pairs from S:

$${\sum }_{( {p}_{i} {p}_{j} ) ∈ S}^{} {\sum }_{k = 1}^{n} {d}_{k} ( {f}_{i} [ k ] , {f}_{j} [ k ] ) {λ}_{k}$$

If pᵢ and pⱼ are not in the same cluster (i.e., (pᵢ,pⱼ) εT), a constraint is formulated. For each such pair, the distance between those two points should be larger than the distance between points from the same cluster.

$${\sum }_{k = 1}^{n} {d}_{k} ( {f}_{i} [ k ] , {f}_{j} [ k ] ) {λ}_{k} - \frac{1}{\vert S \vert} {\sum }_{( {p}_{{i}^{′}} {p}_{{j}^{′}} ) ∈ S} {\sum }_{K = 1}^{n} {d}_{k} ( {f}_{{i}^{′}} [ k ] , {f}_{{j}^{′}} [ k ] ) {λ}_{k} \geq ∈ > 0$$

In the constraint, the first summand is the distance between the two points pᵢ and pⱼ from T. The second term is the normalized optimization goal, the average distance between points from the same cluster. The distance between points from different clusters should to be larger than that, by a certain amount ε>0. Through this definition a large number of constraints are obtained. All the weights are imposed to be nonnegative. By solving the so defined linear program a set of feature weights 830 is obtained. The linear program may not have a solution, but those skilled in the art will recognize that methods exist to produce an approximate solution.

FIG. 9 is a flow diagram illustrating the direct method based on the schematic from FIG. 8. The method starts at 900 and includes obtaining a sample of document pages from a document page collection, as shown in step 907. In step 914, a feature vector set is constructed by extracting features from the first document page from the sample. In step 921, the sample is checked to determine if another document page exists in the sample. If another document page exists, the features from the page are extracted and added to the feature vector set, which consists of the distances of the feature values of the individual pages as shown in step 928. Once all of the document pages in the sample have been reviewed, a classification problem is constructed as shown in step 935. The data to be classified are all pairs of distinct pages, and they are classified as being in the “same cluster” or being in “different clusters” based on a reference clustering as shown in step 942. The classification information may be obtained from looking at a reference clustering. The reference clustering is computed based on the method of FIG. 5. A classifier is trained with the constructed data as shown in step 949. The output classifier, step 956, can be used to extract the feature weights from the classifier as shown in step 963, and the resulting feature weights are ready to be used for clustering the document page collection as shown in step 970.

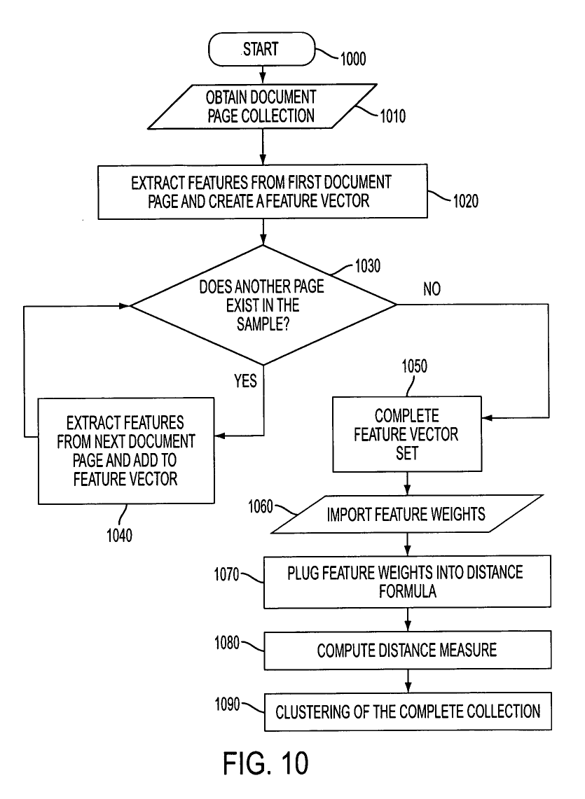

FIG. 10 is a flow diagram illustrating a method of clustering a complete document page collection once the feature weights have been determined. The determination of the feature weights can be accomplished with either of the methods described in FIG. 7 or FIG. 9. The method starts at step 1000 and includes obtaining a document page collection as shown in step 1010. In step 1020, a feature vector set is constructed by extracting features from the first document page from the collection using an electronic document processing system as described above. In step 1030, the collection is checked to determine if another document page exists in the sample. If another document page exists, the features from the page are extracted and added to the feature vector set as shown in step 1040. Once the features from the entire collection of document pages have been extracted, the method proceeds to step 1050, and the feature vector set is complete. In step 1060, the feature weights obtained from either of the methods described in FIG. 7 or FIG. 9 are imported into the electronic document processing system. The feature weights are plugged into the distance formula in step 1070 and a distance measure between any two pages is computed in step 1080. Based on this measure, the complete set of pages represented by their feature vectors can be clustered, as shown in step 1090. The resulting clustering is the output of the method.

A method for computing a distance metric for a document page collection includes obtaining a document page collection, each document page in the collection having one or more features; extracting information from the one or more features on each document page; constructing a feature vector for the one or more features on each document page; assigning a feature weight to each feature; and computing a distance metric based on the feature weight and the feature vector.

A method for evaluating a generated clustering for a document page collection includes obtaining a document page collection, each document page in the collection having one or more features; choosing a sample of document pages from the collection; computing a reference clustering for the sample of document pages; extracting information from the one or more features on each document page in the sample; constructing a feature vector for the one or more features on each document page; assigning a feature weight to each feature; computing a distance metric between any two pages in the sample of document pages based on the feature weight and the feature vector; clustering the sample of document pages using the distance metric in a clustering algorithm to obtain a generated clustering for the sample of document pages; and comparing the reference clustering to the generated clustering.

A method for clustering a document page collection includes obtaining a document page collection, each document page in the collection having one or more features; extracting information from the one or more features on each document page and constructing a feature vector; computing a distance metric based on an assigned feature weight for each feature; and clustering the document page collection using the distance metric.

Although the methods disclosed herein relate to clustering a document page collection, those skilled in the art will recognize that the methods can be used in other clustering approaches, including, but not limited to, a scientist clustering proteins into homology groups; a user clustering document pages for legacy document conversion, a company clustering customers into customer groups, a person clustering web pages into catalogs, and a person clustering images into different groups.

All patents, patent applications, and published references cited herein are hereby incorporated by reference in their entirety. It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for computing a distance metric for a document page collection comprising:
obtaining a document page collection, each document page in the collection having one or more features, the one or more features defining a page layout attribute;
extracting information from the one or more features on each document page;
constructing a feature vector for the one or more features on each document page;
assigning a feature weight to each feature; and
computing a distance metric based on the feature weight and the feature vector.

2. The method of claim 1 wherein the one or more features is a paragraph.

3. The method of claim 1 wherein the information extracted from the one or more features is information selected from the group consisting of the number of paragraphs on each document page, the total area of the paragraphs on each document page, the coordinates of the paragraphs on each document page, the width of the paragraphs on each document page, the height of the paragraphs on each document page, the number of textboxes per paragraph on each document page and the font size of the paragraphs on each document page.

4. The method of claim 1 wherein the one or more features is an image.

5. The method of claim 1 wherein the information extracted from the one or more features is information selected from the group consisting of the number of images on each document page, the total area of the images on each document page, the width of the images on each document page, the height of the images on each document page and the number of SVG-type images on each document page.

6. The method of claim 1 wherein the one or more features includes a paragraph and an image.

7. The method of claim 1 wherein the feature weights are assigned a value based on formulating constraints.

8. A method for evaluating a generated clustering for a document page collection comprising:
obtaining a document page collection, each document page in the collection having one or more features, the one or more features defining a page layout attribute;
choosing a sample of document pages from the collection;
computing a reference clustering for the sample of document pages;
extracting information from the one or more features on each document page in the sample;
constructing a feature vector for the one or more features on each document page;
assigning a feature weight to each feature;
computing a distance metric between any two pages in the sample of document pages based on the feature weight and the feature vector;
clustering the sample of document pages using the distance metric in a clustering algorithm to obtain a generated clustering for the sample of document pages; and
comparing the reference clustering to the generated clustering.

9. The method of claim 8 wherein the one or more features is a paragraph.

10. The method of claim 8 wherein the information extracted from the one or more features is information selected from the group consisting of the number of paragraphs on each document page, the total area of the paragraphs on each document page, the coordinates of the paragraphs on each document page, the width of the paragraphs on each document page, the height of the paragraphs on each document page, the number of textboxes per paragraph on each document page and the font size of the paragraphs on each document page.

11. The method of claim 8 wherein the one or more features is an image.

12. The method of claim 8 wherein the information extracted from the one or more features is information selected from the group consisting of the number of images on each document page, the total area of the images on each document page, the width of the images on each document page, the height of the images on each document page and the number of SVG-type images on each document page.

13. The method of claim 8 wherein the one or more features includes a paragraph and an image.

14. The method of claim 8 wherein the feature weights are assigned a value based on formulating constraints.

15. The method of claim 8 wherein the reference clustering is computed by a user browsing the sample of document pages and clustering the sample by hand.

16. The method of claim 8 wherein the generated clustering and the reference clustering are found to be similar.

17. The method of claim 8 wherein the generated clustering and the reference clustering are found to be dissimilar.

18. The method of claim 17 further comprising:
adjusting the feature weight to each feature;
computing a distance metric between any two pages in the sample of document pages based on the adjusted feature weight and the feature vector;
clustering the sample of document pages using the distance metric in a clustering algorithm to obtain a generated clustering for the sample of document pages; and
comparing the reference clustering to the generated clustering.

19. The method of claim 18 wherein the steps are repeated until the generated clustering and the reference clustering are similar.

20. A method for clustering a document page collection comprising:
obtaining a document page collection, each document page in the collection having one or more features, the one or more features defining a page layout attribute;
extracting information from the one or more features on each document page and constructing a feature vector;
computing a distance metric based on an assigned feature weight for each feature; and clustering the document page collection using the distance metric.
